(19) United States
(12) Patent Application Publication
(10) Pub. No.: US 2003/0043437 A1
(43) Pub. Date: Mar. 6, 2003

(54) Subliminal coherent phase shift keyed in-band signaling of network management information in wavelength division multiplexed fiber optic networks

(76) Inventors: Stephen A. Stough, Campbell, CA (US); Ralph Spickermann, Redwood City, CA (US)

Correspondence Address: Keith D. Nelson, Lockheed Martin Corporation, Building 220, Mail Stop A08, P.O. Box 49041, San Jose, CA, 95161-9041, US

(21) Appl. No.: 09/947,010

(22) Filed: Sep. 4, 2001

(51) Int. Cl. H04B 10/12; H04B 10/04

(52) U.S. Cl. 359/173; 359/183

(57) ABSTRACT

Optical communication systems and methods that provide subliminal in-band signaling of network management information in coherent phase shift keyed (PSK) optical networks. The advantages of this method over various prior art are twofold: (1) It does not require an extra wavelength division multiplexed optical channel to transmit network management data, and (2) it does not require expensive complete time division demultiplexing of the payload data to extract the network management information. The management channel data is transmitted in a spread spectrum signal format that is below the limit of detection in the transmission channel, hence the term subliminal. The subliminal signal is detected using correlative techniques (despreading). The spread-spectrum signal is a direct sequence binary PSK representation of the management channel data plus a spreading code. This spread spectrum signal is superimposed as a slow phase modulation on top of the transmitted high speed PSK payload signal. The high speed PSK data signal acts as a carrier of the spread spectrum signal to the receiver. The spread spectrum phase modulation has a deviation that is smaller than the root mean square phase noise in the fiber optic channel, thereby introducing no measurable increase in the required transmission bandwidth. The subliminally transmitted information is recovered using phase detection of the spread spectrum signal plus noise followed by a conventional despreading operation to raise the signaling information above the level of the received phase noise. The subliminally transmitted management channel info may be recovered at intermediate points in the fiber optic network without expensive complete electronic time division demultiplexing.

### BACKGROUND

The present invention relates generally to optical communication systems and methods, and more particularly, to systems and methods that provide in-band signaling of network management information in wavelength division multiplexed (WDM) fiber optic networks.

The assignee of the present invention designs fiber optic communication systems that communicate data over fiber optic networks. It is desirable to communicate low rate network management data (in addition to the payload data) across the fiber optic network. Network management information includes all messages that need to be exchanged to monitor the performance of the network and to configure it.

Prior art signaling of network management information has often consisted of dedicating an entire WDM optical channel for that purpose. Transmission of relatively low rate management information is a waste of this high capacity channel, as it could otherwise be used for transmitting high speed payload data. Additionally, such a management channel contains the management information associated with all the WDM optical channels on a given fiber. If at some point, a subset of the wavelengths are to be redirected into a different fiber, the management channel must be converted into electrical format and new optical data generated, one for each of the two outgoing paths.

Other prior art involves time division multiplexing the management data with the high speed payload data. This approach avoids the difficulties of the method described above in that the management data associated with a given optical wavelength is transmitted on that same wavelength. Thus, when an optical wavelength is optically switched, its associated management data is also switched. However, extraction of the management channel data at any given point requires expensive full high speed time division demultiplexing of the entire payload data stream.

It is therefore an objective of the present invention to provide for the use of subliminal phase shift keyed signaling of network management information in WDM fiber optic networks in that it does not waste a high speed WDM channel and does not require expensive time division demultiplexing of the high speed payload data. In particular, the present invention provides for the use of such subliminal signaling in connection with the use of coherent quaternary phase shift keying to transmit the payload data. Additionally, because the network management information is not time division multiplexed into the payload data, this method is independent of proprietary custom payload data framing formats.

### SUMMARY OF THE INVENTION

To accomplish the above and other objectives, the present invention comprises optical communication systems and methods that provide phase shift keyed (PSK) subliminal in-band signaling to transmit optical management information in fiber optic networks. The term subliminal is used to mean that the information is transmitted below the noise limit of detection in the transmission channel by the use of spread spectrum correlative techniques.

The present invention involves the superposition of a slow phase modulation onto optical signals transmitted using a fiber optic transmission system or network. The slow phase modulation has a deviation that is smaller than the root mean square phase noise in the fiber optic channel, thereby introducing no measurable increase in the required transmission bandwidth. This superimposed slow phase modulation carries the relatively slow bit rate management channel information. The slow phase modulation is a spread-spectrum (direct sequence) binary PSK representation of the management channel data to be transmitted plus a spreading code. The management channel data is recovered using phase detection of the spread spectrum signal plus noise followed by a conventional despreading operation to raise the management channel signal above the level of the received phase noise. The phase detection of the optical signal is done by means of an electro-optical phase lock loop.

Thus, a spread spectrum signal containing the network management information is superimposed as a relatively slow phase modulation on top of a transmitted payload data stream waveform. The payload data stream waveform acts as a carrier of the spread spectrum signal to the receiver. The receiver extracts the management signal information from the transmitted payload signal using a phase locked loop to perform optical phase detection. The particular modulation format of the high speed payload data stream used in this document is coherent quaternary phase shift keying. As will be shown, in this case the phase locked loop in the receiver already exists to perform optical phase detection to recover the payload data, and the subliminal signal is recovered from the phase error signal sent to the phase locked loop optical local oscillator.

The management channel data may be recovered at intermediate points in the fiber optic link for fault location purposes. This may be done by tapping off a small sample of the optical signal, amplifying it and then performing phase detection followed by despreading. In this way the management channel data may be recovered at intermediate points in the link without expensive time division demultiplexing.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 illustrates an exemplary coherent phase shift keyed optical transmitter in accordance with the principles of the present invention;

FIG. 2 illustrates an exemplary coherent phase shift keyed optical receiver used in conjunction with the transmitter shown in FIG. 1;

FIG. 3 illustrates an exemplary signal tap to facilitate reading the subliminal management channel data at an intermediate point in the link; and

FIG. 4 is a flow chart illustrating and exemplary method in accordance with the principles of the present invention.

### DETAILED DESCRIPTION

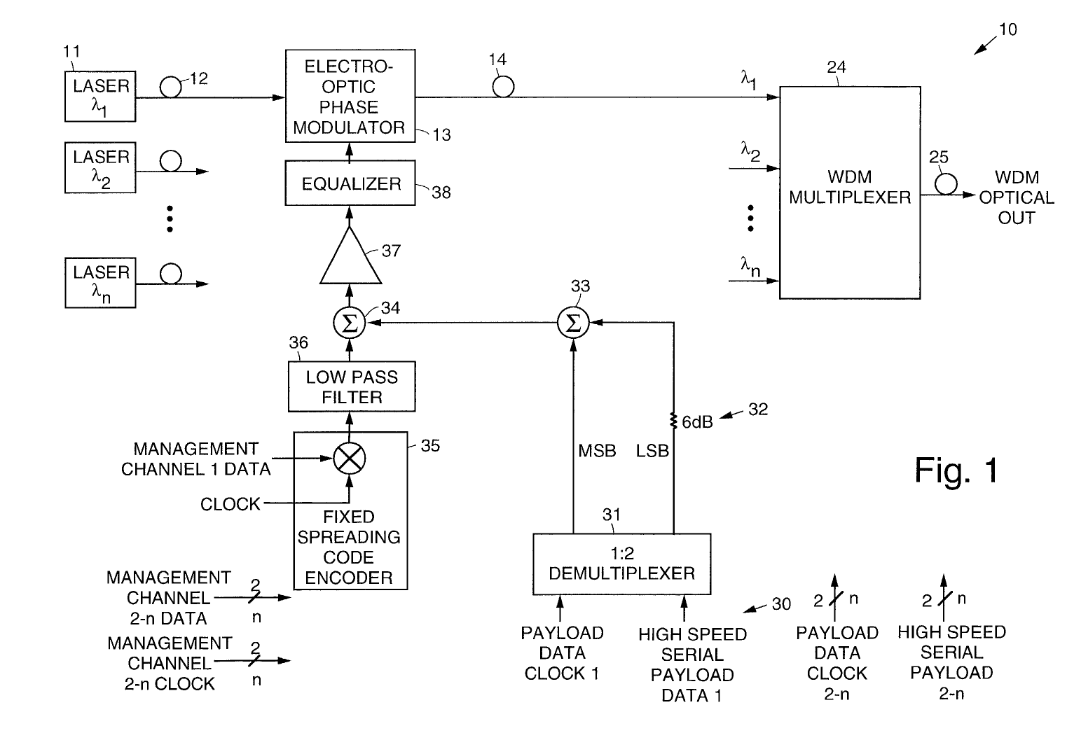

Referring to the drawing figures, FIG. 1 illustrates an exemplary coherent optical transmitter 10 in accordance with the principles of the present invention. The transmitter 10 incorporates a plurality of lasers 1l, each emitting a carrier signal at a different wavelength. The output of the lasers is coupled into a plurality of optical fibers 12. Each optical carrier signal is input to an electro-optic phase modulator 13.

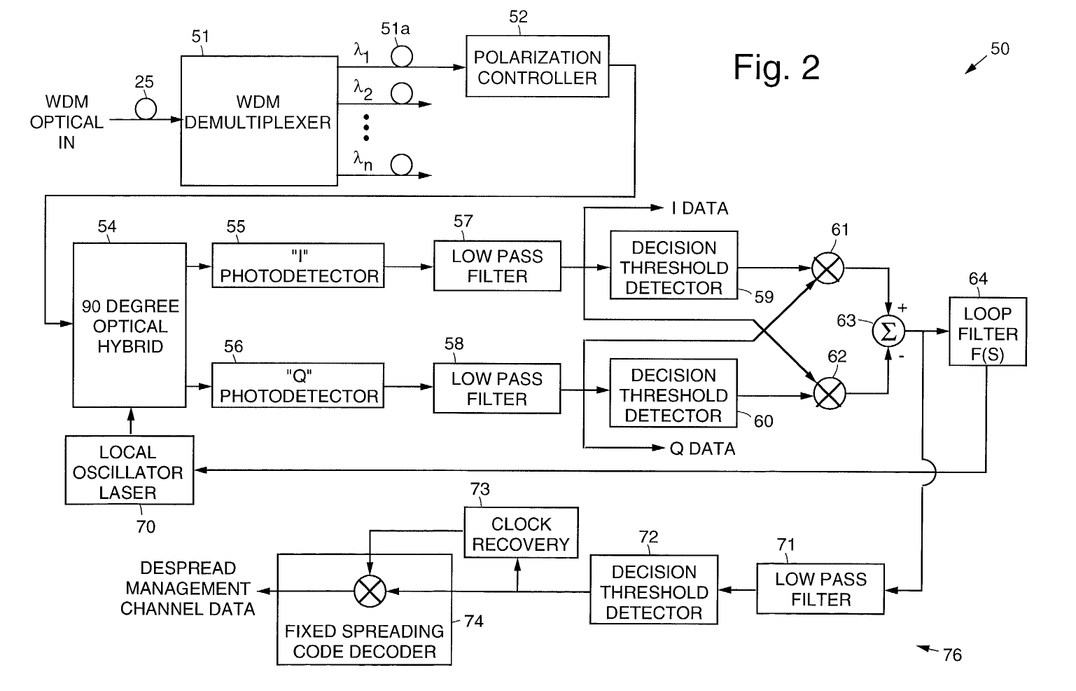

The output of the electro-optic phase modulator 13 is applied to an input of a wavelength division multiplexer 24. The wavelength division multiplexer 24 combines signals corresponding to each of the optical carrier inputs 11. The combined signal is coupled out by way of an optical fiber 25 to a fiber link over which the signal is to be transmitted and then to a receiver 50 (FIG. 2).

Serial input data 30 (sets of data and clock signals), at a 10 Gigabit per second rate, for example, is input to a 1:2 demultiplexer 31. The 1:2 demultiplexer produces pairs of bits at 5 Gigapairs per second.

One bit of a bit pair is attenuated in voltage by one half by a 6 dB attenuator 32. This bit is labeled “LSB” (Least Significant Bit). The unaltered bit is labeled “MSB” (Most Significant Bit). The MSB and LSB are summed in a summing device 33 to yield a 4-voltage level waveform. This 4-voltage level waveform is a 5 Gigasymbol per second waveform with each symbol representing 2 bits of information. This waveform is output to a voltage summing device 34 where it is summed with spread spectrum management channel data.

The spread spectrum management channel data is generated as follows. The low rate management channel data and clock are input into a fixed spreading code encoder 35. The output of the encoder 35 is input to a low pass filter 36 to minimize noise and then is input to the voltage summing device 34.

The output of the voltage summing device 34 comprises a high speed 4-level voltage waveform which embodies payload data at 2 bits per symbol summed with a relatively low speed, low voltage perturbation which embodies the management channel information. The output of the voltage summing device 34 is amplified by an amplifier 37, equalized by an equalizer 38 as appropriate and input to the electro-optic phase modulator 13 so that the electro-optic phase modulator 13 applies an optical phase shift of 0, 90, 180 or 270 degrees in response to the 4-voltage level high speed signal. In this way a high speed quaternary phase shift keyed (QPSK) payload signal is generated with the low speed management channel data superimposed as a perturbation.

The subliminal management channel data may be recovered through phase detection, signal clock regeneration, despreading, and decoding. This recovery process can occur wherever a WDM demultiplexer and phase detector can be inserted into the fiber optic link. FIG. 2 shows an exemplary coherent optical Costas phase locked loop receiver 50 used in conjunction with the QPSK transmitter 10 shown in FIG. 1, and illustrates how the optical phase information of the management signal may be detected as part of a high speed coherent QPSK communication system.

Referring to FIG. 2, the exemplary coherent optical Costas loop receiver 50 receives a WDM signal from the transmitter 10 as transmitted on an optical fiber 25. The WDM signal is input into a WDM demultiplexer 51 which separates the input signals at each wavelength into its own fiber 51a. The plurality of outputs of the WDM demultiplexer 51 are coupled to a plurality of polarization controllers 52.

The output of each polarization controller 52 is coupled to a 90 degree optical hybrid coupler 54. A second input of the 90 degree optical hybrid coupler 54 receives a local oscillator signal derived from a local oscillator laser 70.

In-phase and quadrature (“I” and “Q”) outputs of the 90 degree optical hybrid coupler 54 are coupled to substantially identical photodetectors 55, 56 (“I” and “Q” photodetectors 55, 56) whose outputs are coupled to substantially identical low pass filters 57, 58. The output of each low pass filter 57, 58 is split three ways.

A first output of the I and Q three-way split comprises I and Q payload data for a user. A second output of the I and Q three-way split is input to a pair of substantially identical decision threshold circuits 59, 60 whose outputs are input to a pair of mixers 61, 62. The third output of the I and Q three-way split is input into a second input of the mixers 61, 62. The output of each respective mixer 61, 62 are input to a summing device 63.

The output of the summing device 63 provides a feedback signal that is split into two parts. One part is passed through a loop filter 64 to the local oscillator laser 70. The output of the local oscillator laser 70 is coupled to a second input of the 90 degree optical hybrid coupler 54. The other part is input to management channel data extraction circuitry 76.

The loop feedback signal output from the summing device 63 contains within it the information for the local oscillator laser 70 as to whether it needs to advance or retard in phase to track and maintain phase lock with the incoming signal. As such, this feedback signal contains slow voltage variations that correspond to the slow optical phase perturbations corresponding to the management channel data that was transmitted.

The management channel data is extracted from the loop feedback signal as follows. The second output of the summing device 63 is coupled by way of a low pass filter 71 to a digitizing decision threshold circuit 72. The output of the decision circuit 72 is split into two parts. One part is input into clock recovery circuitry 73. A clock output from the clock recovery circuitry 73 is input into a fixed spreading code decoder 74. The detected data output from the digitizing decision threshold circuit 72 is also input into the fixed spreading code decoder 74, which outputs the desired transmitted management channel data.

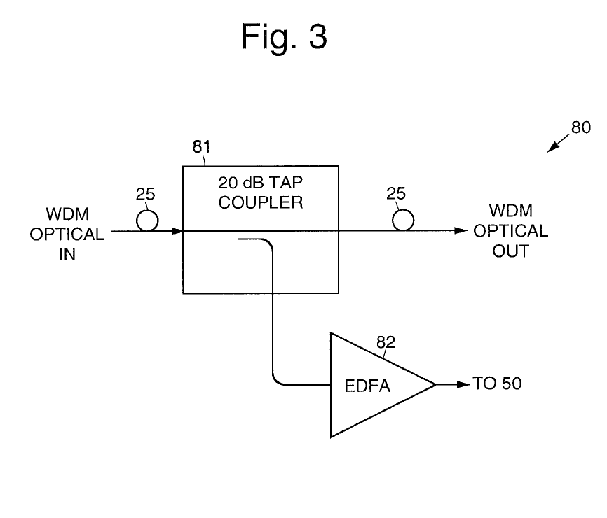

FIG. 3 illustrates how the management channel data may be extracted at an intermediate point in the link. Link tap equipment 80 includes a 20 dB coupler 81 that couples a small sample of the WDM signal from the link fiber 25 into an amplifier 82, such as an erbium doped fiber amplifier (EDFA) 82. Most of the signal continues on the link fiber 25. The amplifier 82 amplifies the tapped optical signal to power level equivalent to the power level on the link fiber 25. The output of the amplifier 82 is sent to an optical receiver 50 (such as is shown in FIG. 2) for phase detection and management channel data extraction.

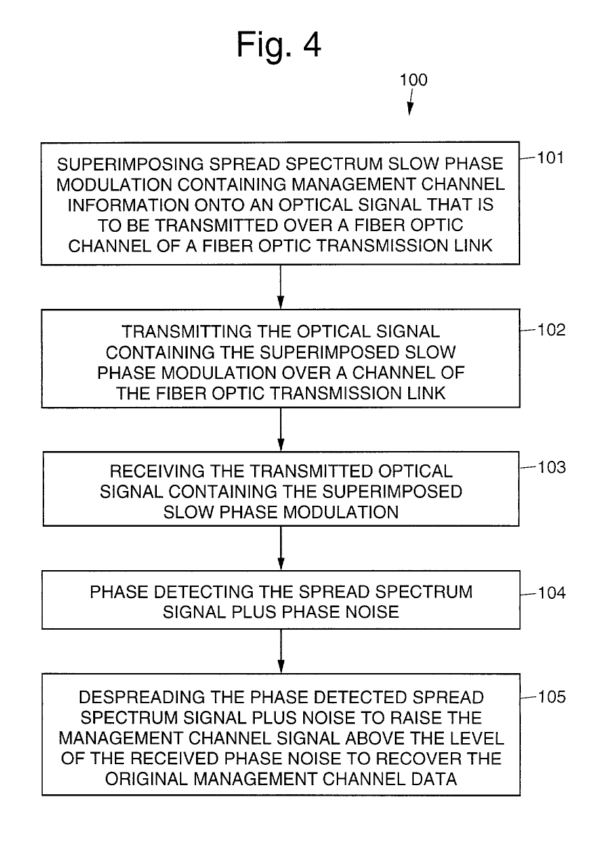

FIG. 4 is a flow chart illustrating an exemplary method 100 in accordance with the principles of the present invention. The method 100 implements phase shift keyed subliminal in-band signaling to transmit optical management information over a fiber optic network. The exemplary method 100 comprises the following steps.

A slow phase modulation containing management channel information is superimposed 101 onto an optical signal that is to be transmitted over a fiber optic channel of a fiber optic transmission link, wherein the slow phase modulation has a deviation that is smaller than the root mean square phase noise in a fiber optic channel, thereby introducing no measurable increase in the required transmission bandwidth. The superimposed slow phase modulation carries the relatively slow management channel information, and is a spread-spectrum (direct sequence) binary PSK representation of the management channel data to be transmitted plus a spreading code.

The optical signal containing the superimposed slow phase modulation is transmitted 102 over a channel of the fiber optic transmission link. The transmitted optical signal containing the superimposed slow phase modulation is received 103 by a receiver.

The original management channel data is recovered by phase detecting 104 the spread spectrum signal plus phase noise and despreading 105 the phase detected spread spectrum signal plus noise to raise the management channel signal above the level of the received phase noise. Phase detecting 104 the optical signal is done using an opto-electronic phase lock loop.

Thus, a spread spectrum signal containing the network management information is superimposed as a relatively slow phase modulation on top of a transmitted payload data stream waveform. The payload data stream waveform acts as a carrier of the spread spectrum signal to the receiver. The receiver extracts the management signal information from the transmitted payload signal using a phase locked loop. The particular modulation format of the high speed payload data stream used in this document is coherent quaternary phase shift keying. In this case the phase locked loop in the receiver already exists to recover the payload data, and the subliminal signal is recovered from the phase error signal sent to the phase locked loop optical local oscillator.

In should be clear that the present invention superimposes a low speed subliminal phase modulation onto high speed light signals transmitted over a fiber optic transmission system or network. The low speed modulation is intended for use in transmitting optical network management information. The phase modulation is described as subliminal, in that the transmitted information is below the limit of detection in the high speed transmission channel.

Detection of the information requires the use of correlative techniques (despreading). The phase modulation has a deviation that is smaller than the root mean square phase noise in the fiber optic transmission channel, thereby making no measurable increase in the required transmission bandwidth. The phase modulation is a spread-spectrum (direct sequence) binary-phase-shift keyed representation of the management channel data plus the spreading code.

The management channel data may be recovered at intermediate points in the fiber optic network so that the network configuration and its performance can be monitored. The management channel data is recovered using phase detection of the spread spectrum signal plus noise followed by despreading to raise the signaling information above the level of the received phase noise.

Thus, systems and methods that provide subliminal in-band signaling in optical fiber optic networks have been disclosed. It is to be understood that the above-described embodiment is merely illustrative of some of the many specific embodiments that represent applications of the principles of the present invention. Clearly, numerous and other arrangements can be readily devised by those skilled in the art without departing from the scope of the invention.

What is claimed is:

1. Optical transmitting apparatus comprising:
a coherent optical transmitter for superimposing a spread spectrum slow phase modulation containing management channel information onto an optical signal that is to be transmitted over a fiber optic channel of a high speed fiber optic transmission link and transmitting the optical signal containing the superimposed slow phase modulation over a channel of the high speed fiber optic transmission link;
a receiver at a receiving end of a high speed fiber optic link for receiving the transmitted optical signal containing the superimposed slow phase modulation and phase detecting the spread spectrum signal plus phase noise and despreading the phase detected spread spectrum signal plus noise to raise the management channel signal above the level of the received phase noise to recover the original management channel data.

2. The apparatus recited in claim 1 wherein the slow phase modulation has a deviation that is smaller than the root mean square phase noise in a fiber optic channel. thereby introducing no measurable increase in the required transmission bandwidth of the link.

3. The apparatus recited in claim 1 wherein the superimposed slow phase modulation that carries the relatively slow management channel information is a spread-spectrum binary phase shift keyed representation of the management channel data to be transmitted plus a spreading code.

4. The apparatus recited in claim 1 wherein the receiver comprises an electro-optical phase lock loop for processing the optical signal.

5. Optical transmitting apparatus comprising:
a coherent optical transmitter that comprises:
a plurality of signal channels that each comprise:
a laser that outputs a carrier signal at a predetermined wavelength;
an electro-optic phase modulator for receiving the carrier signal and generating a phase modulated carrier signal;
a 1:2 demultiplexer for receiving serial input data comprising sets of data and clock signals that outputs pairs of bits;
a summing device for summing the pairs of bits to produce a 4-voltage level waveform;
a fixed spreading code encoder for receiving management channel data and clock signals and for generating low rate spread spectrum management channel data;
a low pass filter for filtering the low rate spread spectrum management channel data;
a voltage summing device for summing the 4-voltage level waveform with the spread spectrum management channel data to generate a high speed 4-level voltage waveform and a low speed, low voltage perturbation comprising the management channel data; and
an amplifier for amplifying the high speed 4-level voltage waveform and coupling it to the electro-optic phase modulator thereby generating a high speed quaternary phase shift keyed payload data optical signal with the management channel data superimposed as a phase perturbation; and
a wavelength division multiplexer coupled to the electro-optic phase modulator of each signal channel for combining the phase modulated carrier signals to generate a wavelength division multiplexed output signal for transmission over a fiber optic link: and
a receiver at a receiving end of the a fiber optic link for recovering the management channel data and the serial input data that comprises:
a wavelength division demultiplexer that separates the received signals at each wavelength into a plurality of signal channels that each comprise:
a polarization controller;
a 90 degree optical hybrid coupler having a first input coupled to an output of the polarization controller and having a second input coupled to receive a local oscillator signal output by a local oscillator laser, and that outputs in-phase (I) and quadrature (Q) outputs;
I and Q photodetectors coupled to respective outputs of the hybrid coupler;
I and Q low pass filters respectively coupled to the I and Q photodetectors that respectively output I and Q payload data;
I and Q decision threshold circuits respectively coupled to outputs of the I and Q photodetectors;
I and Q mixers respectively coupled to outputs of the I and Q low pass filters and the I and Q photodetectors;
a summing device coupled to outputs of the I and Q mixers that outputs a feedback signal;
a loop filter for filtering the feedback signal and coupling the filtered feedback signal to an input of the local oscillator laser; and
management channel data extraction circuitry for processing the feedback signal to recover the management channel data comprises

6. The apparatus recited in claim 5 wherein one bit of a bit pair output by the 1:2 demultiplexer is coupled to one input of the summing device and the other bit of the bit pair is attenuated in voltage by an attenuator and is coupled to one input of the summing device.

7. The apparatus recited in claim 5 wherein the management channel data extraction circuitry comprises:
a low pass filter for filtering the feedback signal;
a digitizing decision threshold circuit for processing the filtered feedback signal detecting the management channel data;
clock recovery circuitry for processing the detected management channel data to recover the clock signal therefrom; and
a fixed spreading code decoder for processing the recovered clock signal and the detected management channel data to generate the transmitted management channel data.

8. The apparatus recited in claim 5 wherein the loop feedback signal output by the summing device comprises information for the local oscillator laser as to whether it needs to advance or retard in phase to track the signal input to the optical hybrid.

9. The apparatus recited in claim 5 wherein the feedback signal contains slow voltage variations that correspond to the slow optical phase changes corresponding to the management channel data that was transmitted.

10. The apparatus recited in claim 5 further comprising an intermediate management channel data recovery circuit disposed at a predetermined location in the fiber optic link that comprises:
a coupler for tapping off a sample of the optical signal transmitted over the fiber optic link;
an amplifier for amplifying the sampled optical signal; and
an optical receiver for phase detecting the spread spectrum signal and phase noise contained in the sampled optical signal and for despreading the management channel data to raise the level of the management channel signal above the level of the phase noise.

11. An optical signaling method comprising the steps of:
superimposing a slow phase modulation containing spread spectrum management channel information onto an optical signal that is to be transmitted over a fiber optic channel of a fiber optic transmission link;
transmitting the optical signal containing the superimposed slow phase modulation over a channel of the fiber optic transmission link;
receiving the transmitted optical signal containing the superimposed slow phase modulation;
phase detecting the spread spectrum signal plus phase noise and despreading the phase detected spread spectrum signal plus noise to raise the management channel signal above the level of the received phase noise to recover the original management channel data.

12. The optical signaling method recited in claim 11 wherein the slow phase modulation has a deviation that is smaller than the root mean square phase noise in a fiber optic channel, thereby introducing no measurable increase in the required transmission bandwidth of the link.

13. The optical signaling method recited in claim 11 wherein the superimposed slow phase modulation that carries the relatively slow management channel information is a spread-spectrum binary phase shift keyed representation of the management channel data to be transmitted plus a spreading code.

14. The optical signaling method recited in claim 11 wherein the step of phase detecting the optical signal comprises processing the optical signal using an electro-optical phase lock loop.
